(19) United States
(12) Patent Application Publication
(10) Pub. No.: US 2013/0043334 A1
(43) Pub. Date: Feb. 21, 2013

(54) Method and apparatus having a low manufacturing cost for chopping food

(71) Applicant: Allan Goldscher, Los Angeles, CA (US)

(72) Inventor: Allan Goldscher, Los Angeles, CA (US)

(21) Appl. No.: 13/506,338

(22) Filed: Apr. 12, 2012

Related U.S. Application Data
(60) Provisional application No. 61/575,137, filed on Aug. 17, 2011.

(51) Int. Cl. B02C 18/26; A47J 43/28

(52) U.S. Cl. 241/25; 241/169; 241/29

(57) ABSTRACT

A high inertia cylindrical mass element having one or more food chopping blades detachably affixed thereto is positioned within a transparent cylindrical tube containing food to be chopped. The tube containing the high inertia cylindrical mass element is dimensioned to permit the tube to be moved back-and forth much more than the mass element is moved therein due to the high inertia of the cylindrical mass upon the manually induced to-and-fro motion of the tube by the user that results in chopping of the food. In addition to creating the back-and forth movement of the tube, the user also twists the ends of the tube with her wrists while the tube is grasped which results in relative rotary displacement of the tube relative to the high inertia cylindrical mass carrying cutting blades that tends to chop the food more uniformly.

### RELATED APPLICATIONS

This application claims the benefit of provisional application 61/575,137 filed Aug. 17, 2011.

### BACKGROUND OF THE INVENTION

U.S. Pat. No. 7,975,947 issued to Horstmann on Jul. 12, 2011 discloses a food chopper that operates by a back-and-forth manual translation of an inertia mass element having a set of food cutting blades thereon. Eight cutting blades are disclosed coupled to the mass element as shown in FIG. 3, and a special structure is disclosed for inducing rotation of the cutting blades to tend to enhance the dicing effect of the food chopper.

### BRIEF SUMMARY OF PREFERRED EMBODIMENTS OF THE INVENTION

The special structure of the Hortstmann patent for inducing blade rotation has been eliminated in order to simplify the chopper design to save manufacturing cost of the chopper. Also, in order to simplify the chopper design, the number of blades has been reduced to two blades and even one blade is believed sufficient to chop the food. The provision of one or two blades makes blade cleaning easier as the space between blades is sharply increased.

The preferred method of chopping food in accordance with a preferred method of the invention calls for the steps of

(a) providing a food chopper:

having a high inertia mass element having one or more food chopping blades coupled thereto along with a tube for containing the high inertia mass element and dimensioned to permit the high inertia mass to slide relative to the tube upon to-and-fro motion of the tube; and

at least one lid coupled to a terminal portion of the tube for inserting food to be chopped within the tube;

(b) inserting the high inertia mass element or weighted blade disk, and food to be chopped into the tube; and

(c) manually translating the tube back-and forth and rotating the tube for providing translational and rotary motion of the high inertia mass relative to the tube, thereby to enhance uniform chopping of the food within the tube. This feature of the invention results in the desired simplification of the food cutter design mentioned in the background section, saving manufacturing costs.

### BRIEF DESCRIPTION OF THE DRAWINGS

FIG. 1 shows a front view of the high inertia mass element.

FIG. 2 shows a side view of this structure.

FIG. 3 shows a top view of the structure in FIG. 2.

FIG. 4 illustrates the high inertia mass element with its cutting blades positioned within the food cutter tube.

FIG. 5 shows a single blade embodiment to further save manufacturing costs.

### DETAILED DESCRIPTION OF PREFERRED EMBODIMENTS OF THE INVENTION

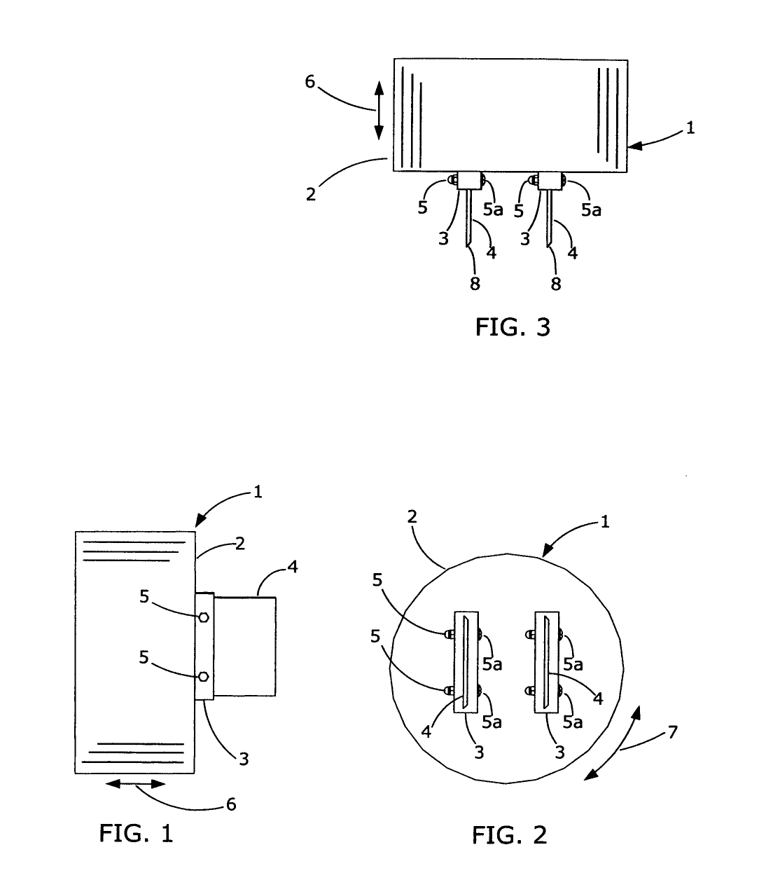

In FIGS. 1 and 2, the movable chopper member 1 consists of a cylindrical low inertia mass 2 having blades 4 coupled to mass 2 via coupling members 3 having a pair of removable fasteners 5 for securing the blades to mass 2.

The side view of FIG. 1 shown in FIG. 2 shows two coupling members 3 for detachably coupling two blades 4 to the cylindrical mass 2. Thus new blades can be substituted for old worn blades if desired. The use of screws 5 and their associated nuts 5a are preferred as they enable easy decoupling or removal of worn blades from the mass 2 and thereafter coupling new sharpened blades to the mass. However, rivets or the like may be employed if blade replacement may not be called for.

The structure of FIG. 2 is shown in the top view of FIG. 3. Note that the blade tips 8 are beveled to enhance food cutting action.

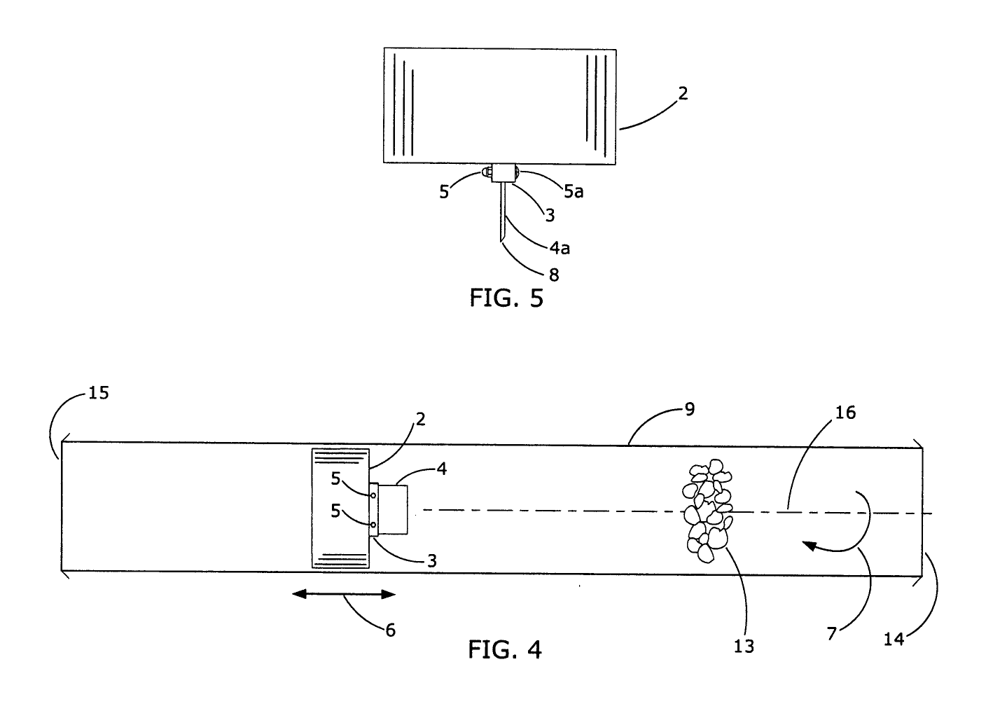

FIG. 4 shows the high inertia mass or weighted blade disk 2 with its associated cutting blades 4 of FIGS. 1-3 positioned within transparent cylindrical tube 9, whereby the cutting blades 4 face the food to be cut 13 that the user positions within the cylindrical tube 9.

The tube preferably has “snap-on” flexible rim type lids at its ends. Lid 14 is removed to enable the food 13 to be cut to be inserted within the cylindrical tube and is thereafter closed. The lid 15, which is optional, can be removed to facilitate cleaning of the inside surfaces of the cylindrical tube. Plastic cylindrical tubes are widely available having open ends or having one end permanently closed.

In accordance with the invention, the user grabs the first and second lids with her hands and shakes or translates the cylinder back and forth whereby the mass 2 having substantial inertia, will slide within the tube moderately relative to the larger back-and forth or two-and-fro movement or translation of the cylindrical tube. This results in chopping of the food by the blades affixed to the low inertia mass. The double headed arrow 6 indicates the back-and-forth translation of the cylindrical tube by the user to effect food chopping action.

In addition, the user rotates the cylindrical tube by manually twisting the ends of the tube with her wrists, as indicated by arrow 7 about longitudinal axis 16, in addition to the translational tube motion indicated by arrow 6. Arrows 6 and 7 are also shown in FIGS. 1 and 2 respectively. These rotary motions result in rotary slippage of the tube relative to the inner cylindrical mass 2 to tend to produce more uniform slicing or dicing of the food. This rotary action asserted upon the ends of the tube can be performed simultaneously with the back-and forth tube translation or can be performed separately from the back-and forth or two-and-fro action induced upon the tube by the user.

The cylindrical mass 2 has a diameter slightly less than the internal diameter of the widely available transparent plastic cylinder to enable smooth relative motion of the plastic tube relative to the cylindrical mass 2.

The aforesaid “snap-on lids” widely used on food containers are commercially available; see www.usplastic.com/catalog for purchasing these lids.

The cylindrical mass 2 would typically made of stainless steel and would typically have a diameter of about 1.5 inches. Of course much variation in size and materials could be employed.

As indicated in FIG. 5 it is believed feasible to only employ one blade 4a, to further reduce manufacturing costs.

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the following claims.

The term “high inertia” as applied to the cylindrical mass element 2 means that the mass element has sufficient inertia to produce the aforesaid relative motions between the tube and the cylindrical mass element.

What is claimed is:

1. A food chopper comprises:
(a) an high inertia mass element having one or more food chopping blades coupled thereto;
(b) a tube containing said high inertia mass element and dimensioned to permit said high inertia mass element to slide relative to said tube upon to-and-fro motion of said tube; and
(c) at least one lid coupled to a terminal portion of the tube for inserting food to be chopped within said tube.

2. The food chopper of claim 1 wherein only two food chopping blades are coupled to said high inertia mass element.

3. The food chopper of claim 1 wherein first and second lids are removably mounted upon first and second ends of said tube respectively for enhancing cleaning of the inner portions of the tube.

4. The food chopper of claim 2 wherein first and second lids are removably mounted upon first and second ends of said tube respectively for enhancing cleaning of the inner portions of the tube.

5. The food chopper of claim 1 wherein said high inertia mass and said tube are cylindrical bodies.

6. The food chopper of claim 2 wherein said high inertia mass and said tube are cylindrical bodies.

7. The food chopper of claim 3 wherein said high inertia mass and said tube are cylindrical bodies.

8. The food chopper of claim 4 wherein said high inertia mass and said tube are cylindrical bodies.

9. A method of chopping food comprising the steps of:
(a) providing a food chopper having
(a-1) a high inertia mass element having one or more food chopping blades coupled thereto;
(a-2) a tube for containing said high inertia mass element and dimensioned to permit said high inertia mass to slide relative to said tube upon back-and forth motion of said tube; and
(a-3) at least one lid coupled to a terminal portion of the tube for inserting food to be chopped within said tube;
(b) inserting the high inertia mass element and food to be chopped into the tube; and
(c) translating the tube back-and forth and rotating the tube for providing translational and rotary motion of the high inertia mass relative to the tube, thereby to enhance uniform chopping of the food within the tube.

10. The method of claim 9 wherein the step of rotating the tube is performed while translating the tube back-and-forth.

11. The method of claim 9 wherein rotating the tube is performed by manually rotating a person's wrist while holding on to the tube.

12. The method of claim 10 wherein rotating the tube is performed by manually rotating a person's wrist while holding on to the tube.

13. The method of claim 9 including the step of replacing old worn blades with new blades by decoupling the old worn blades from the high inertia mass and coupling the new blades to the high inertia mass.

14. The method of claim 9 wherein only a single blade is affixed to the high inertia mass.

15. A method of chopping food comprising the steps of:
(a) providing a food chopper consisting of
(a-1) a high inertia mass element having one or more food chopping blades coupled thereto;
(a-2) a tube for containing said high inertia mass element and dimensioned to permit said high inertia mass to slide relative to said tube upon to-and-fro motion of said tube; and
(a-3) at least one lid coupled to a terminal portion of the tube for inserting food to be chopped within said tube;
(b) inserting the high inertia mass element and food to be chopped into the tube; and
(c) translating the tube back-and forth and rotating the tube for providing translational and rotary motion of the high inertia mass relative to the tube, thereby to enhance uniform chopping of the food within the tube.

16. The method of claim 15 wherein only a single blade is affixed to the high inertia mass.

17. The method of claim 15 wherein the step of rotating the tube is performed while translating the tube back-and forth.

18. The method of claim 15 wherein rotating the tube is performed by manually rotating a person's wrist while holding on to the tube.

19. The food chopper of claim 1 wherein only a single blade is affixed to the high inertia mass.

20. The food chopper of claim 1 wherein said food chopping blades are detachable from the high inertia mass.
